(19) United States
(12) Patent Application Publication
(10) Pub. No.: US 2013/0272253 A1
(43) Pub. Date: Oct. 17, 2013

(54) Dynamic Assignment of a Serving Network Node

(71) Applicants: Pieter Veenstra, The Hague (NL); Colin Pons, Rotterdam (NL)

(72) Inventors: Pieter Veenstra, The Hague (NL); Colin Pons, Rotterdam (NL)

(73) Assignee: KONINKLIJKE KPN N.V., The Hague (NL)

(21) Appl. No.: 13/990,688

(22) PCT Filed: Nov. 14, 2011
(86) PCT No.: PCT/EP2011/070010

§ 371 Date: May 30, 2013

(30) Foreign Application Priority Data
Nov. 30, 2010 (EP) 10193057.6
Jun. 24, 2011 (EP) 11171297.2

(51) Int. Cl. H04W 72/04

(52) U.S. Cl. CPC H04W 72/0486
USPC 370/329

(57) ABSTRACT

A method and a system for dynamic assignment of a serving network node in a communications network, preferably an IMS-based communications network, are described, wherein the communications network comprises a predetermined number of serving network nodes and wherein the method comprises: receiving a service request associated with a user equipment, another network or a network node, preferably an application server; providing load information associated with said serving network nodes; and, in response to said service request, assigning one of said predetermined number of serving network nodes to said user equipment, said other network or said network node on the basis of said load information.

### FIELD OF THE INVENTION

The invention generally relates to dynamic assignment of a serving network node in a communication network and, in particular, though not necessarily, to a method and a system for dynamically assignment of a serving network node in a communications network, to a network node configured for dynamic assignment of a serving network node in a communications network, a subscriber database server and a location server for use with such network node and a computer program product using such method.

### BACKGROUND OF THE INVENTION

Due to random nature of signaling traffic and/or software and hardware failures associated with nodes in a communications network, it is inevitable to have network anomalies that can potentially result in an overload situation or even a partial collapse of a communications network. In an IP-based Next Generation Network (NGN) such as a communications network based on the 3GPP IMS architecture, a serving network node function such as the S-CSCF handles all major tasks in the control layer, including registration and routing of signaling, session control and service routing with Application Server (AS) assistance. Hence, overload or other types of failures of such serving network node (e.g. an S-CSCF) may thus cause severe performance degradation, activate packet re-transmission, an unrecoverable server collapse or even a partial collapse of the network. This sensitivity to failure of essential elements in a network may also be exploited by attackers through malicious attacks associated with multiple SIP session set-up and tear-down signaling in order to disrupt the IMS network.

Proposals have been put forward for preventing such failures. For example, for overload situations in particular, the overload of the S-CSCF in TR 23.812 v 1.1.2 proposed scheme which relies on the registration process. In this scheme, the conventional 3GPP IMS architecture provides a form of load balancing wherein at registration the I-CSCF may select a best-fit S-CSCF for the UE. After registration however, the P-CSCF, S-CSCF and a signaling path are rigidly coupled to a UE for an entire registration period which may be up to typically 24 hours or more. Any failure of the S-CSCF during the registration period may cause severe network problems.

A further registration-based overload prevention scheme is described by Liang Xu et. al. in their article “De-registration based S-CSCF load balancing in IMS core network” IEEE International Conference 14-18 Jun. 2009 ICC'09 Dresden. The authors propose a load balancing scheme based on forced de-registration when overload conditions are detected at a S-CSCF and re-registering with another less loaded S-CSCF.

Such overload prevention schemes however have the disadvantage that the IMS registration process in the current 3GPP IMS architecture is a relatively signaling intensive process. Multiple de-registrations may cause an avalanche of re-registrations that in turn may cause undesired performance degradation of the IMS core. Further, as the registration procedure is rather complex, it is relatively slow and may occur infrequent so that it provides a mechanism which is less suitable for generating a fast and effective response to an emerging overload situation.

Additionally, these proposed load balance schemes cannot deal with services, e.g. business trunking services, which do not rely or which rely only partly on the conventional IMS registration procedure. For example, in an IP-based enterprise network—usually referred to as a Next Generation Corporate Network (NGCN)—one or more IP private branch exchanges (IP-PBX) may manage the connections among the enterprise communications devices (e.g. wireline phone, wireless phone, soft client) and the interoperability to the circuit- or packet switched network. The NGCN may be connected to the PSTN or an IP-based network through a trunk, which represents a single logical connection between the two networks.

In such a constellation typically many users may be served via a single trunk whereby the number of active end-users may vary significantly over time and across such trunk lines. Due to recent trends such as increased home working and the availability of flexible office hours, the load of a trunk line is very unpredictable and sensible to high variations which may cause congestion problems when using a conventional IMS network.

If a NGCN for example relies on a subscription-based business trunking scheme in the IMS network, then the individual end-users served by the NGCN are statically connected to the IMS network via “surrogate registration” in association with business trunking as e.g. described in ETSI TS 182.025. Surrogate registration, or also referred to as implicit registration, may be based on a wild card mechanism in the HSS causing groups of end-users to be registered as a single entity in the IMS network. The implication is that all service requests to and from this NGCN are served by the same S-CSCF during the registration period. Above this the suggested S-CSCF load balancing by re-registration will result in selection of the same, already assigned S-CSCF in the case of active sessions with the NGCN. Because of these group characteristics of the registration methods for business trunking, distributing the routing of signaling traffic in the IMS network over different S-CSCF entities in an IMS network for individual end-users within a group is not possible.

Alternatively, if the NGCN relies on a peering-based business trunking scheme, there is no registration in the IMS network of any specific identities of the end-users served by the NGCN.

Traditional telecommunications engineering have shown that call set-up (or call arrival) signaling in TDM based networks such as PSTN has a Poisson distribution. In IMS however the arrival distribution at the S-CSCF is affected by the P-CSCF and IBCF (both functions often implemented on a SBC), especially in the scenario of users served by trunks to an SBC and/or P-CSCF or IBCF wherein the P-CSCF or IBCF may be highly utilized so that distribution of requests arriving at an S-CSCF does not have to exhibit a Poisson distribution. Furthermore, new services e.g. presence updates, messaging, video sharing and others (e.g RCS), which have a highly unpredictable arrival distribution of signaling messages further add to this unpredictability. Hence, conventional solutions for preventing overload conditions cannot be or at least are very difficult to be implemented in an IP-based communication networks such as IMS.

In the article by Makaya et.a. “Load balancing support for self-organizing IMS networks” (submitted for the IEEE Consumer Communications and Networking Conference Jan. 9-11, 2011) a scheme for an IMS network is proposed wherein continuity of a session after failure of a network element, e.g. a P-CSCF or S-CSCF, is achieved. This scheme however deals only with support during failure but not address the problem of preventing network node failures due to e.g. overload.

Hence, there is a need in the art for improved methods and systems for dynamic assignment of a serving network node. In particular, there is a need in the art for methods and systems for allow dynamic assignment of a serving network node to a user equipment or network node such that overload and fault situations in the IMS core may be avoided or at least minimized.

### SUMMARY OF THE INVENTION

It is an object of the invention to reduce or eliminate at least one of the drawbacks in the prior art. In one aspect, the invention may relate to a method for dynamic assignment of a serving network node in a communications network, comprising a predetermined number of serving network nodes. In one embodiment, the communications network may relate to an IMS-based communications network. Said method may comprise: receiving a service request e.g. a SIP INVITE request associated with a user equipment, another network or a network node, preferably an application server; providing load information associated with said serving network nodes; and, in response to said service request, assigning one of said predetermined number of serving network nodes to said user equipment, said other network or said network node on the basis of said load information. Hence, the method allows at each originating and/or terminating service request received by the network to select a serving network node on the basis of actual signaling load and status information associated with the serving network nodes. Whereas in the prior art a serving node is assigned in response to the receipt of a registration request (which is a different request than a service request and which results in a fixed assignment of the serving network node during the full registration period of the user equipment or said other network), with the method according to the invention, this assignment is flexible and may only be fixed for the period in between the receipt of consecutive service requests from the same user equipment (or other network). Hence this solution provides in general a more fine grained method for load balancing signaling traffic routed via serving network nodes and/or for the load balancing of the processing load, for example CPU load, of the serving network nodes.

In an embodiment such service request is a SIP based service request, not being a SIP based request for registration or re-registration.

In a further embodiment such service request is an Initial Dialogue Request, preferably a SIP INVITE message.

In one embodiment said load information is provided at regular time intervals. This has the advantage that, depending on the time interval chosen, load information is kept up-to-date according to a predetermined time scheme.

In a further embodiment said load information is provided in response to said service request. This allows the use of the latest available load information in the assignment process of around the time of the request.

In a further embodiment said providing of load information may be performed by a Load Detection Function (LDF), preferably one as described in 3GPP TR 23.812. This way overload situations or fault conditions (e.g. assignment of a UE to a (partially) defect S-CSCF) may be avoided. Further, the overall response time of the individual S-CSCFs may be kept low so that a good throughput of signaling messages is achieved under all circumstances. Moreover, the proposed solution further allows stabilization of the network during overload conditions and prevention of a complete collapse of one or more serving network nodes, e.g. S-CSCFs.

In yet a further embodiment said providing of load information may further comprise the receipt of said load information by a Load Balancing Function from a Load Detection Function (such as the one described in 3GPP TR 23.812), preferably at the request of the Load Balancing Function.

In one embodiment such request is made by the Load Balancing Function, in response to the receipt of a service request.

In one embodiment said communications network may further comprise at least one location database comprising location information, preferably a network address, associated with said predetermined number of serving network nodes; and, optionally, assignment information identifying user equipment or a network node assigned to at least one of said predetermined number of serving network nodes. A location database may contain the location information of network nodes assigned to a particular UE or IP-PBX (NGCN).

In another embodiment said load information may comprise response time information and/or CPU resource information associated with at least part of said serving network nodes. The load information allows the communications network to select a best-fit serving network node (e.g. an S-CSCF) at each service request of a UE on the basis of information which is up-to-date and/or on information associated with previously assigned S-CSCFs. Such system is thus capable of rapidly responding to load change in individual network nodes of a communications network thereby effectively preventing overload situations.

In a further embodiment of the method according to the invention, the assignment of the serving network node is performed by the aforementioned Load Balancing Function.

In yet a further embodiment, said assignment is performed at the request of a requesting network node, preferably a P-CSCF, an I-CSCF, or an I-BCF, in response to the receipt of a service request by said requesting network node.

In a further embodiment information regarding the assigned serving network node is sent to the requesting network node, preferably in response to the assignment according to the invention. This enables the requesting network node to forward the service request to the assigned serving network node.

In an embodiment the method for dynamic assignment of serving network nodes may be adjustable for continuous operation or for operation during selected time intervals. This has the advantage that at peakload hours the dynamic assignment method according to the invention as claimed, may be automatically switched on, and during low use (nightly hours), it may be switched off. In yet other embodiments the aforementioned method may be adapted for distinguishing between received service requests, thereby only dynamically assigning a serving network node according to the invention as claimed for one or more predetermined services and/or one or more predetermined UEs, or other networks from which the service request may originate (for example NGCNs). This has the further advantage of selectively using the method as claimed. For example frequent users (in other words heavy users, those that frequently generate new service requests) may be distinguished from infrequent users, whereby the dynamic assignment method is only applied to the frequent users.

In yet another embodiment said method may further comprise: receiving a list identifying at least part of said predetermined number of serving nodes, said list further comprising location information associated with said serving node; receiving load information associated with at least part of said predetermined number of serving nodes; selecting a serving network node on the basis of selection rules and said load information; assigning said selected serving network node to said user equipment or said application server.

In one embodiment said method may comprise: registering an user equipment on the basis of an access network node, preferably a P-CSCF associated with said communications network; and, optionally storing location information, preferably an network address, associated with said assigned serving network node in said location database.

In another embodiment said method may comprise: assigning an access network node at the border of said communications network, preferably a P-CSCF or a session border controller, to said user equipment; executing a registration function associated with said access network node; storing said registration in a subscriber database, preferably a UPSF/HSS, comprising user profiles associated with subscribers to services of said communications network; storing location information, preferably the network address associated with said access network node in a location database. In this embodiment registration with the communications network is enabled directly via a registering network node located at the edge of an administrative domain, e.g. the P-CSCF or the SBC, to the HSS. This way the signaling load of the S-CSCF due to registration processes may be eliminated and threats originating from repeated registration and de-registrations with the malicious intend to disrupt the IMS core may be avoided or at least significantly reduced

The registration further provides the effect that upon registration only the UE (IP-PBX) and the registering network node (the P-CSCF or the SBC) are tightly coupled to each other during the relatively long period of registration. During this registration period, which is kept by a registration timer, the system may allow changes in the serving network node serving an UE on the basis of the signaling load of individual network nodes in the IMS core.

In an alternative embodiment of the method according to the invention, wherein the service request is a request for originating services, the step of assigning a serving network node comprises the overruling of any previous assignment of a serving network node, whereby such previous assignment is performed at registration of the user equipment or other network.

The benefit of this embodiment is that it allows ordinary assignment, such as defined in IMS standards 3GPP TS 23.228 and TS 24.229, of a serving network node during the registration process of user equipment or other network. Hence this part of prior art, preferably IMS, registration procedures need not be modified. This ordinary assignment at registration is not used for routing purposes in case service requests for originating services are received, these are routed to the serving network nodes by the assignment process of the method according to the invention. However service requests for terminating services may still be routed to serving network nodes assigned during registration of the user equipment or other network. Hence this embodiment enables the treatment of service requests for originating services in a load balanced manner, whilst at the same time allows for treatment of service requests for terminating services in the conventional manner.

In a further embodiment said method may comprise: sending said service request to said assigned serving network node; the assigned serving network node requesting a user profile associated with said user equipment if a memory of said assigned serving network node does not comprise said user profile.

In yet another embodiment, said method may further comprise: routing said service request to an application server comprising a service associated with the service request.

In one variant said service request may be a terminating service request wherein said location database further may comprise location information associated with access network nodes assigned to user equipment registered with the communications network. Said method may further comprise: if the terminating user equipment associated with said terminating service request is registered with said communications network, requesting said location database for the location information of said access network node associated to the terminating user equipment.

In another variant said method may comprise: routing said terminating service request via said access network node to said terminating user equipment.

In yet another variant said method may comprise: updating a user profile associated with a subscriber to services of said communications network; in response to said user profile update, deleting user profiles stored in a memory of at least part of said predetermined number of serving network nodes. In a further variant said method may comprise: sending a user profile update message to a subscriber database, preferably a UPSF/HSS, comprising user profiles associated with subscribers to services of said communications network; updating said user profile in said subscriber database; said subscriber database requesting location information associated with at least a part of said predetermined number of serving network nodes; transmitting a user profile refresh message to said serving network nodes; if said user profile is stored in a memory, removing said user profile entry from said memory. This variant ensures that a serving network node does not process messages on the basis of user profiles which are no longer valid. This way a serving network node will always use the most recent user profile available in the UPSF/HSS.

In a further variant said service request may be received by an SBC, an P-CSCF, an IBCF, an S-CSCF or an I-CSCF. The method thus enables an overload prevention mechanism which may be implemented at various network nodes of the communications network.

In yet a further variant said location database may be co-located with said UPSF/HSS or wherein said location database is located on a separate network node.

In another aspect, the invention may relate to a network node, preferably an SBC, an P-CSCF, an IBCF, an S-CSCF or an I-CSCF, configured for dynamic assignment of a serving network node in a communications network, preferably an IMS-based communications network, wherein said network node may comprise: means for receiving a service request associated with an user equipment, an IBCF or a network node, preferably an application server; means for providing load information associated with at least part of said predetermined number of serving network nodes, preferably said load information comprising response time information and/or CPU resource information; means for assigning one of said predetermined number of serving network nodes to said user equipment or said network node when said receiver receives a service request, said assigning being based on said load information.

In one embodiment said network node may further comprise: means for sending assignment information identifying user equipment or a network node assigned to at least one of said predetermined number of serving network nodes.

In another embodiment said network node may further comprise:

means for receiving a user profile refresh message;
means for removing a user profile entry from a memory of said network node if said memory comprises the user profile identified in said user profile refresh message.

In a further aspect, the invention may relate to a server comprising a subscriber database, preferably a UPSF/HSS, comprising user profiles associated with subscribers to a communications network, said communications network comprising a predetermined number of serving network nodes and a least one network node, preferably an SBC, a P-CSCF, an IBCF, an S-CSCF or an I-CSCF, configured for dynamic assignment of a serving network node to a user equipment, another network or an application server, wherein said server may comprise: means for updating a user profile stored in a memory of said server; means for receiving location information associated with at least a part of said predetermined number of serving network nodes; means for transmitting a user profile refresh message to said serving network nodes, so that if said user profile is stored in a memory of one or more of said serving network nodes, said serving network node will remove said user profile entry from said memory.

In yet a further aspect, the invention may relate to a location server for use with a network node as described above, said server comprising a location database comprising location information, preferably network addresses, associated with said predetermined number of serving network nodes; assignment information identifying user equipment, another network or a network node assigned to at least one of said predetermined number of serving network nodes; and location information associated with access network nodes assigned to user equipment registered with the communications network, wherein said location server may comprise: means for receiving and transmitting assignment information identifying user equipment, another network or a network node assigned to at least one of said predetermined number of serving network nodes; means for receiving and transmitting location information associated with said predetermined number of serving network nodes and/or said with access network nodes assigned to user equipment registered with the communications network.

The invention may also relate to a computer program product, wherein the computer program product comprises software code portions configured for, when run by a computer, executing the method according to any of the methods described above.

The invention will be further illustrated with reference to the attached drawings, which schematically show embodiments according to the invention. It will be understood that the invention is not in any way restricted to these specific embodiments.

### BRIEF DESCRIPTION OF THE DRAWINGS

FIG. 1 depicts a schematic of at least part of a Next Generation Network.

FIG. 2 depicts a schematic of a conventional system for registration of an UE to an IMS core.

FIG. 2b depicts a modified signaling flow associated with registration of a UE to an IMS core according to an embodiment of the invention

FIG. 3 depicts a schematic of a system for registration of an UE to an IMS core according to one embodiment of the invention.

FIG. 4 depicts a signaling flow associated with an implementation wherein a registration function RF is located in the P-CSCF.

FIG. 5 depicts a signaling flow associated with a re-registration with the IMS.

FIG. 6 depicts a schematic of a system for routing a terminating service request according to one embodiment of the invention.

FIG. 7 depicts a schematic of a system for routing a originating service request according to another embodiment of the invention.

FIG. 8 depicts a signaling flow associated with a process for setting up the originating side of a session.

FIG. 9 depicts a schematic of a system for routing a terminating service request according to another embodiment of the invention (S-CSCF known).

FIG. 9b depicts an alternative schematic of a system for routing a terminating service request according to one embodiment of the invention.

FIG. 10 depicts a system for routing a terminating service request according to yet another embodiment of the invention (S-CSCF unknown).

FIG. 11 depicts a system for P-CSCF localisation according to various embodiments.

FIG. 12 depicts a signaling flow associated with a process for setting up the terminating side of a session.

FIG. 13 depicts a system for routing a terminating service request according to a further embodiment of the invention (S-CSCF unknown; UE not registered)

FIG. 14 depicts a signaling flow associated with a process for setting up a session based on a service request originating from another network.

FIG. 15 depicts a signaling flow associated with a process for setting up a first part of a session in a roaming situation.

FIG. 16 depicts a signaling flow associated with a process for setting up a second part of a session in a roaming situation.

FIG. 17 depicts a signaling flow associated with a process for setting up a session wherein an application server initiates the session service request.

FIG. 18 depicts a scheme for updating a user profile according to one embodiment of the invention.

### DETAILED DESCRIPTION

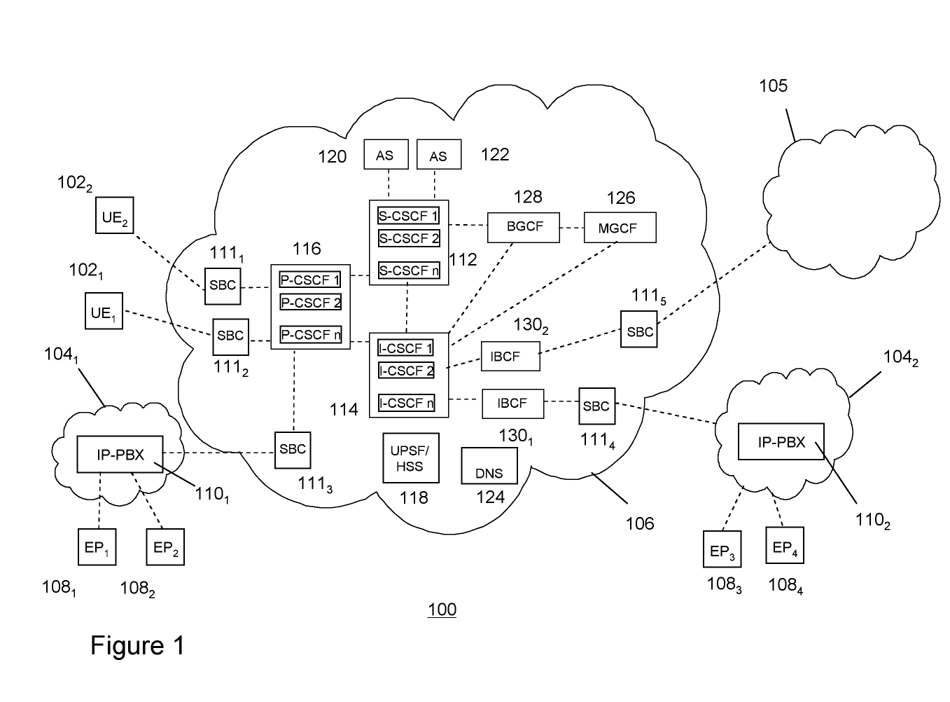

FIG. 1 depicts a schematic of at least part of an NGN service provisioning system 100. In particular an IMS-based service provisioning system, comprising individual user equipments UEs 102_{1,2} and/or one or more other networks, such as other public networks 105, e.g. IP-based networks of different public network operators, and/or NGCNs 104_{1,2}, i.e. IP-based enterprise networks, connected to an IMS core 106.

A UE may typically relate to a wireline and/or wireless phones, SIP phones, etc. An IP private branch exchange (IP-PBX) 110₁₋₂ associated with the enterprise network may be responsible for controlling the End Points on the enterprise premises as well as the management of the required services. End-Points (EPs) (i.e. terminals) 108₁₋₄ used in the enterprise network may comprise wireline and/or wireless phones, SIP phones, etc. The UEs and the NGCNs in FIG. 1 are connected to the IMS core using session border controllers (SBCs) 111₁₋₄ for handling the SIP signaling interface, topology hiding and interworking with non-IMS networks.

The IMS core may typically comprise Call/Session Control Functions (CSCF), including Proxy-CSCFs (P-CSCF) 116, Interrogating-CSCFs (I-CSCF) 114 and Serving-CSCFs (S-CSCF) 112. A P-CSCF is typically one of the elements of first contact within the IMS core. Using routing information established during the registration to the IMS core, it routes signaling messages (e.g. SIP INVITE) to the S-CSCF associated with a UE. The IBCF (130) (or I-CSCF) is located at the edge of a domain and identifies the correct S-CSCF for incoming SIP requests and forwards the request to that S-CSCF. Its IP address is published in the DNS (not shown) of the domain so that remote servers can find it. The IBCF is a function, usually implemented on a SBC, (as well as the P-CSCF may be implemented on a SBC on the User Network Interface (UNI)), whereby the SBC may also host other functions. In FIG. 1 the IBCF is shown separate from the SBC, whereby the SBC merely forwards incoming messages to the IBCF functions. Further, the S-CSCF performs the session control services and—in the conventional IMS architecture—acts as a SIP registrar.

Registration of a UE with the IMS in accordance with a conventional IMS registration procedure involves the transfer of a user (service) profile associated with a subscriber to the IMS network to the S-CSCF. A user profile is stored in a database 118 (usually referred to as the Home Subscriber Service (HSS) database or the User Profile Server Function (UPSF)) and may be sent to the S-CSCF over the Cx interface in a standardized XML format. A user profile comprises routing information for routing signaling messages that are either originated from or addressed to a particular UE or one or more trusted application servers 120,122.

The IMS system may comprise other elements (functional entities or functions) like DNS 124, MGCF 126 and BGCF 128 of which their mode of operation need not be necessarily changed for implementing the invention.

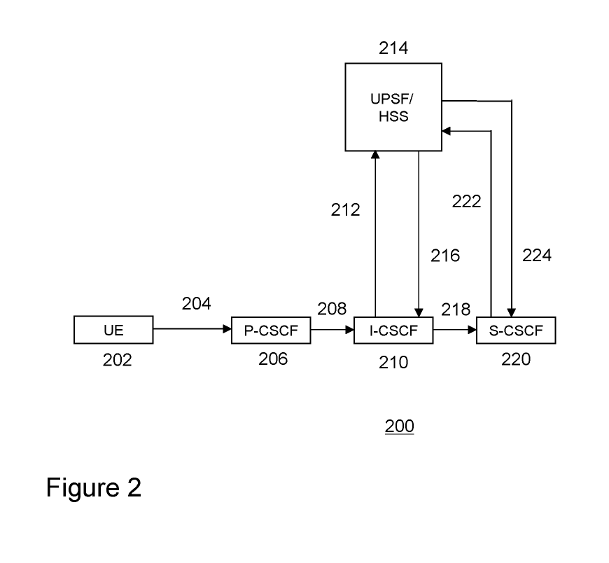

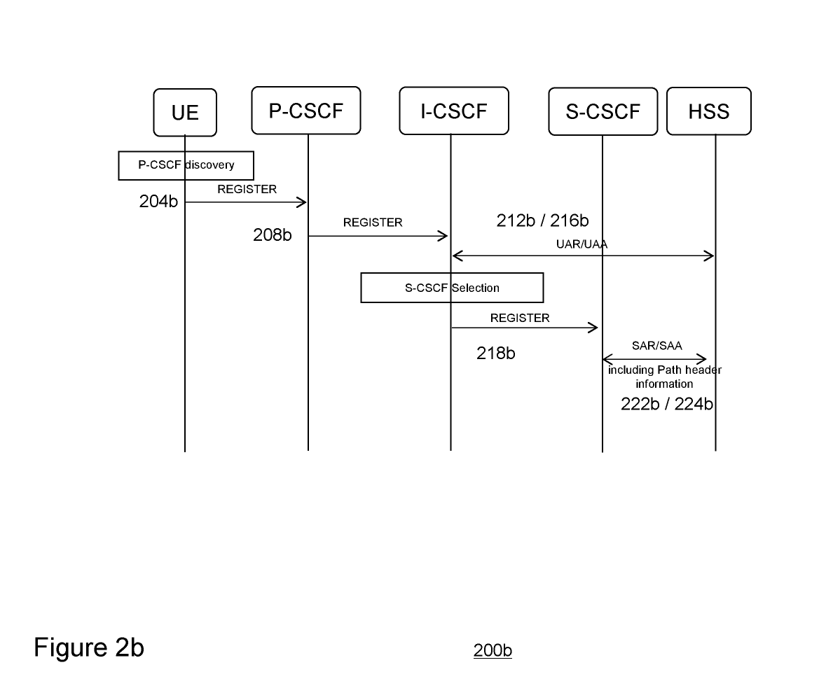

FIG. 2 depicts a schematic 200 of a conventional IMS registration procedure. The registration process may involve a UE 202 transmitting a registration message 204,208 e.g. a SIP REGISTER message, via the SBC (not shown) and the P-CSCF 206 to the I-CSCF 210 of the IMS core. Upon receipt of the registration message 204,208, the I-CSCF may send a request 212 for capabilities information to the HSS 214, which in response sends the requested capabilities information to the I-CSCF (step 216). This information is subsequently used by the I-CSCF to select a suitable S-CSCF 220. Capabilities information may include load information associated with the available S-CSCFs so that at registration the assignment of a heavily loaded S-CSCF may be avoided. The registration message may then be forwarded to the selected S-CSCF serving the UE (step 218), which subsequently authenticates the user with the HSS (step 222). After successful authentication and registration, the HSS may load the S-CSCF with the service profile of the UE comprising routing information (step 224).

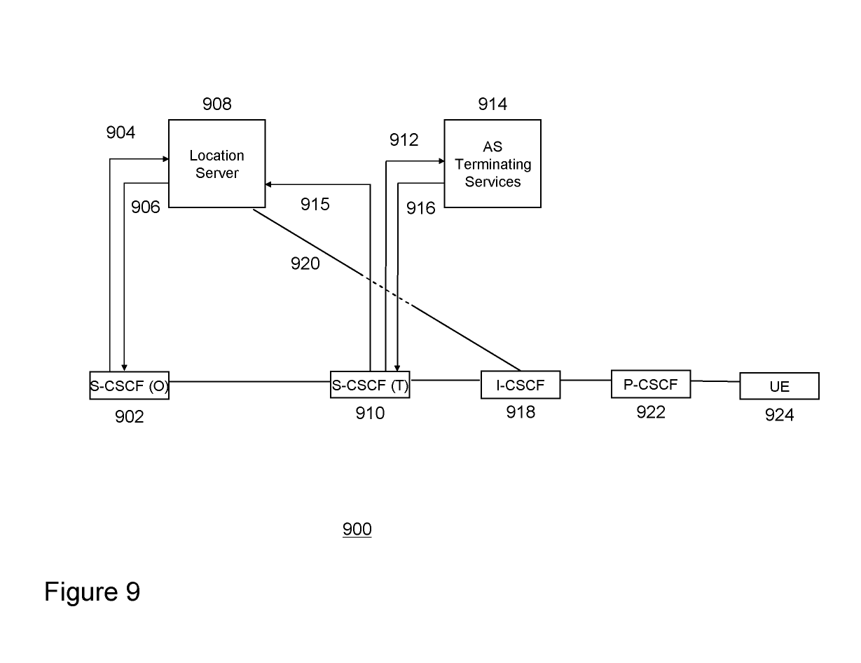

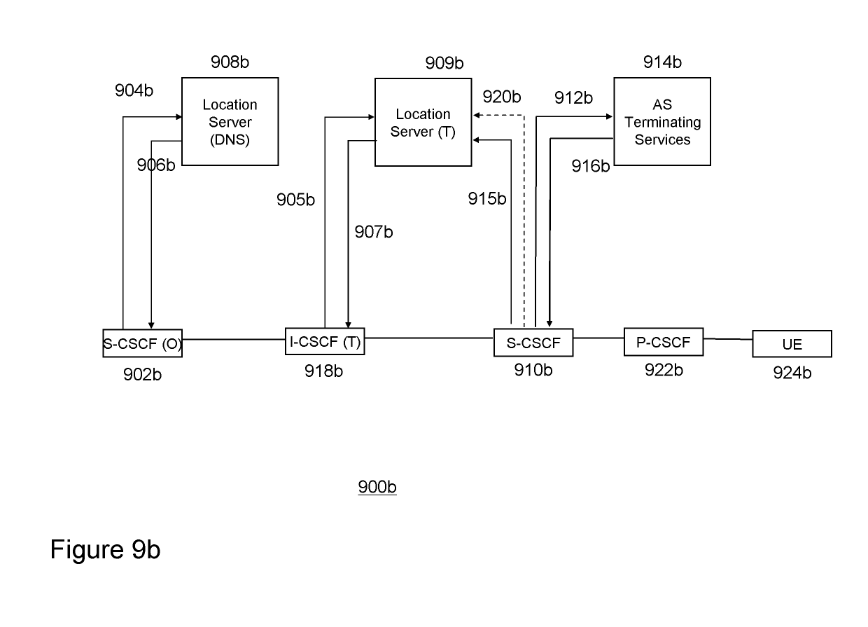

FIG. 2b depicts a signaling flow for a modified registration process according to one embodiment of this invention. In this signaling flow a UE issues a SIP REGISTER request (204b) to a previously discovered P-CSCF (according to the conventional IMS registration procedure). The P-CSCF subsequently forwards the REGISTER request (208b) to the I-CSCF of the home network (according to the conventional IMS registration procedure). The I-CSCF selects an appropriate S-CSCF via a User-Authorization-Request (UAR)(212b)/User-Authorization-Answer (UAA) (216b) query to the HSS (according to the conventional IMS registration procedure). The I-CSCF subsequently forwards the REGISTER request to the selected S-CSCF (218b) (according to the conventional IMS registration procedure). The S-CSCF subsequently notifies the HSS about the current registration via a Server-Assignment-Request (SAR) (222b)/Server-Assignment-Answer (SAA) (224b) query (according to the conventional IMS registration procedure). In addition to the conventional IMS registration procedure, the S-CSCF in the registration procedure according to one embodiment of the invention now includes the SIP Path header information in the received REGISTER message in the SAR message to the HSS. The HSS stores this Path header information in association with the user profile of the registered user equipment for later use during a terminating service request handling according to an embodiment of the invention as further detailed in FIG. 9b.

The services may be identified by a set of initial filter criteria (iFC) in or associated with the user service profile. An iFC may be generally regarded as service routing rules comprising a filter part and a decision part, wherein the filter part comprises so-called Trigger Points, defining one or more filter criteria, which are applied to the incoming service message. The decision part specifies the action(s) to be taken when the incoming message matches with the filter criteria of the rule. The iFC thus comprises information for determining whether or not a SIP message should be routed to a service located in a particular application server. The iFCs are defined in the standard in paragraph B.2.2 of document 3GPP TS 129 228, which is hereby incorporated by reference in this application.

Now turning back to FIG. 1, the application servers (AS) 120,122 may comprise services e.g. voice-centric (VoIP) and/or multimedia services. The VoIP application server may provide a minimum set of features to support the call routing to and from UEs or NGCNs and regulatory and billing requirements. Further, at least one application server may comprise trunking services such as overflow behavior services, wherein certain connections are grouped in an ordered list to handle traffic in a specified manner and/or to handle load behavior services wherein a list of connections that are part of the same trunk will be used in a specified manner to handle the traffic.

If an NGCN 104₁ relies on a subscription-based business trunking scheme, registration of an IP-PBX to the IMS core may involve an SBC 111₃ registering on behalf of the NGCN both the IP-PBX and all individual terminals associated with the IP-PBX via the P-CSCF 116 to the IMS core. Such registration process may involve the transmission of a registration message, e.g. a SIP REGISTER message, via the SBC and the P-CSCF to the I-CSCF of the IMS core in a similar way as described above in relation to individual UEs. After successful authentication and registration, the HSS may provide the S-CSCF with service routing information, allowing the S-CSCF to register the IP-PBX with one or more services in one or more application servers by sending a registration message (such as a SIP REGISTER message) to the application servers identified in the service routing information.

NGCNs are not necessarily connected to the IMS platform based on the subscription-based business trunking scheme. An NGCN may also be configured not to register with the IMS core. Instead an NGCN 104₂ may be directly connected via at least one trunk to an Interconnection Border Control Function (IBCF) 130, which may be co-located with the SBC 111₄.

The use of a direct interconnection between the NGCN and the NGN through the IBCF provides the advantage that the IP-PBX and individual users associated with the NGCN are not required to register with the IMS core. Hence problems with regard to “surrogate registration” by the SBC may be avoided and allow the NGN to provide the NGCN with services, including trunking services. The use and the associated advantages of such peering based business trunking scheme are described in pending European Patent applications no. EP10177037.8 and EP 10177055.0, which are hereby incorporated by reference.

In the NGN as depicted in FIG. 1, after registration, individually registered UEs 102 and subscription based NGCNs 104 are tightly coupled with the P-CSCF, I-CSCF and a selected S-CSCF for the duration of the registration period, which may be typically 24 hours or more. Only after the registration period, an UE and/or NGCN may be re-registered with the IMS core, wherein the I-CSCF 114 may perform a certain form of load-balancing or failure control by selecting on the basis of the capabilities information associated with the available S-CSCFs a different, more suitable S-CSCF. Alternatively, as described before, the NGN may also be directly interconnected with one or more NGCNs (other networks) without the use of the conventional registration procedure. In such scheme load balancing on the basis of the registration procedure is not possible at all.

Hence, conventional load balancing schemes on the basis of the registration procedure can provide only very limited forms of load balancing and/or failure control, which are not suitable for responding to fast load fluctuations or node failures and for preventing individual network nodes in the IMS core from overloading. In particular, these schemes are not suitable for preventing network node failures due to e.g. overload. This problem may be solved by configuring the IMS core such that a network node, in particular the serving network node in the IMS core such as the S-CSCF, may be selected upon a service request. Whereas a service request for the purpose of this invention is not to be understood as a (re-)registration request (or (re-)registration message). In this way, at each originating and/or terminating service request received by the IMS core a network node may be selected on the basis of actual signaling load and status information associated with the serving network nodes around the time of the request so that overload situations or fault conditions (e.g. assigned of a UE to a (partially) defect S-CSCF) may be avoided. In that way the overall response time of the individual S-CSCFs may be kept low so that a good throughput of signaling messages is achieved under all circumstances. The proposed solution further allows stabilization of the network during overload conditions and prevention of a complete collapse of one or more S-CSCFs.

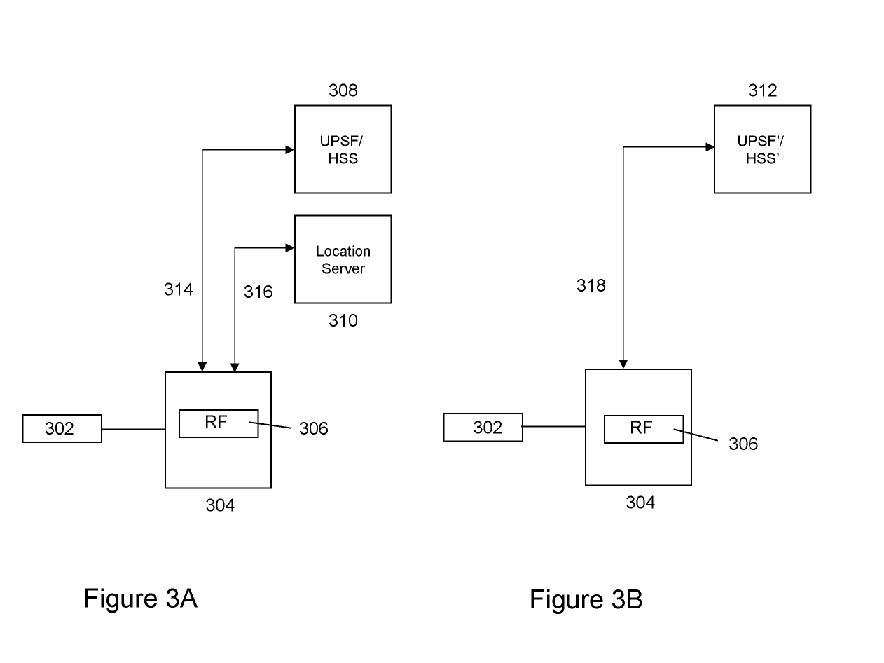

The details of an IMS system for efficiently balancing the signaling load, according to embodiments of the invention, are described hereunder with reference to FIG. 3.

For the purpose of the invention the terms NGCN and IP-PBX may be used interchangeably. Both refer either to a peering based arrangement (104₂ in FIG. 1) or to a subscription based arrangement (104₁ in FIG. 1). The latter may send service requests to an IMS system, in a manner equivalent to the registration of/sending of service requests by individual User Equipments. The term other network comprises the terms NGCN or IP-BX as well as any public network (105 in FIG. 1)

FIGS. 3A and 3B depict schematics of systems for registration of an UE or an NGCN to an IMS core according to one embodiment of the invention. In particular, in FIG. 3A an UE or NGCN 302 may send a registration message, e.g. a SIP REGISTER message, to a registering network node 304 associated with the IMS core comprising a registration function 306 (RF).

The registering network node may be implemented in various ways. In one embodiment, the registering network node may relate to a P-CSCF comprising a RF for registering and authenticating the UE to the IMS core. In another embodiment, the registering network node may be implemented as a SBC comprising a RF. In yet another embodiment, the registering network node may be implemented as a SBC comprising P-CSCF functionality.

When the registering network node receives the registration message, the RF is activated, which subsequently registers and authenticates the UE with the USSF/HSS 308 in accordance with the requirements under the appropriate standard. When successfully registered, the RF queries a location server 310 for a location update comprising location information, typically an IP address, on the network node (P-CSCF or SBC) to which the UE or IP-PBX (NGCN) is assigned. After successful registration, the user profile in the HSS reflects that the UE is registered with the IMS core and the location database comprises the location information to which P-CSCF or SBC (comprising P-CSCF functionality) the UE is assigned to during a registration period. The location server comprising the location database may be implemented as separate entity or co-located with the HSS (not shown).

FIG. 3B depicts an alternative registration scheme, which differs from the one depicted in FIG. 3A in that the RF registers and authenticates the UE or IP-PBX (NGCN) with a modified USSF'/HSS' 312, so that during the registration the location information associated with the network node (P-CSCF or SBC) to which the UE or IP-PBX is assigned, is stored in the user profile so that when an S-CSCF is requesting a user profile, it will also receive the location of the P-CSCF assigned to the UE.

Hence, in accordance with the registration schemes depicted in FIGS. 3A and 3B, the authorization (as part of the registration process) is performed at the border of a trust domain, i.e. the P-CSCF or the SBC. Such registration procedure differs from the current 3GPP IMS registration procedure wherein authorization is executed by the S-CSCF, right in the center of a trust domain, which makes the core network vulnerable to misbehaving UEs, IP-PBXes and other malicious attacks.

When registering directly via a registering network node located at the edge of an administrative domain, e.g. the P-CSCF or the SBC (comprising a P-CSCF function), to the HSS, the signaling load of the S-CSCF due to registration processes may be eliminated and threats originating from repeated registration and de-registrations with the malicious intend to disrupt the IMS core may be avoided or at least significantly reduced.

The registration systems depicted in FIG. 3A/B further provide the effect that upon registration only the UE (IP-PBX) and the registering network node (the P-CSCF or the SBC) are tightly coupled to each other during the relatively long period of registration (also referred to as the “registration period”). During this registration period, which is kept by a registration timer, the system may allow changes in the serving network node (S-CSCF) serving an UE on the basis of the signaling load of individual serving network nodes in the IMS core.

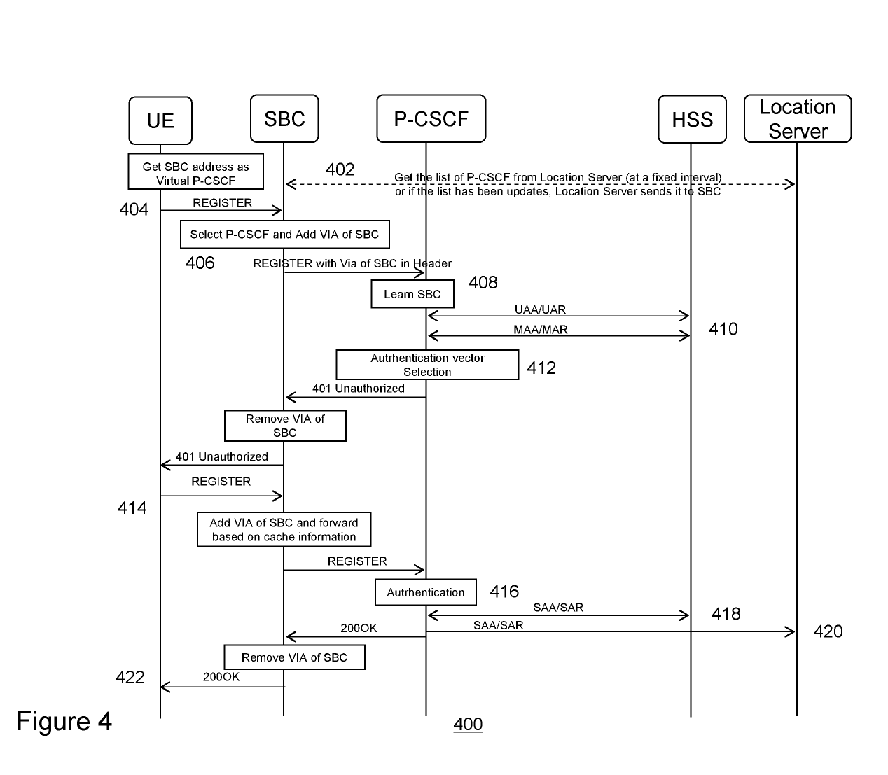

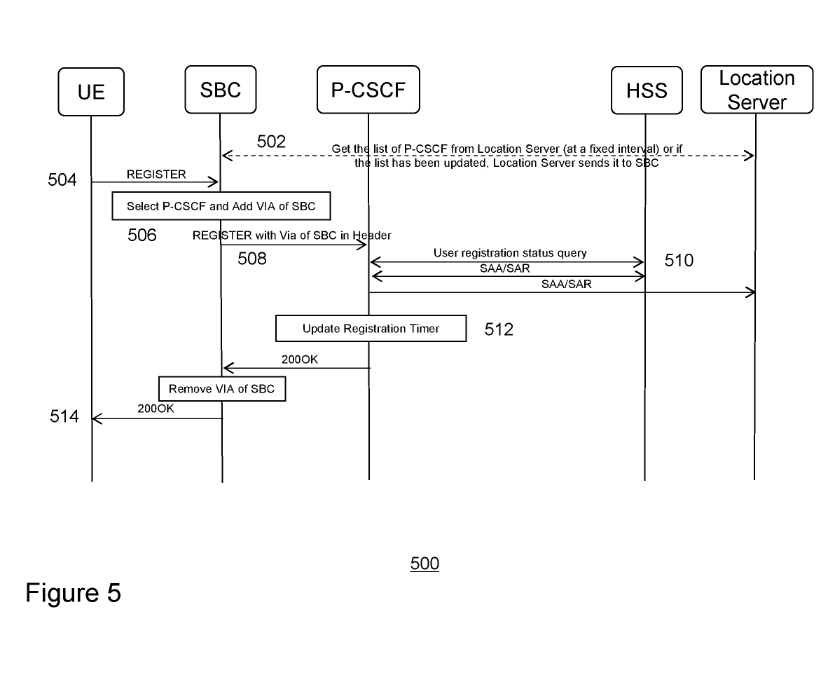

FIGS. 4 and 5 depict signaling flows associated a registration process in accordance with one embodiment of the invention. In particular, FIG. 4 depicts a signaling flow 400 associated with an implementation wherein a registration function RF is located in the P-CSCF and wherein the RF is configured to register and authenticate to a HSS and to store the location (e.g. its IP address) of the P-CSCF assigned to an UE in a location database (which may be contained in a location server).

In this process, the SBC associated with the UE may request a list of available P-CSCFs from the location server or, alternatively, the location server may provide the SBC with a list of available P-CSCFs at regular intervals (step 402) for example on the basis of information from a load detection function as proposed in 3GPP TR 23.812. Then, when an unregistered UE sends a registration message to the SBC (step 404), the SBC may select a P-CSCF in accordance with a certain policy function (step 406) and relay the registration message to the selected P-CSCF (step 408). The P-CSCF subsequently stores the SBC address and requests the HSS (step 410) for one or more authentication vectors comprising authentication parameters, i.e. a random value RAND, an Authentication token AUTN, a signed result XRES, a Cipher Key CK and an Integrity Key IK. The information exchange between the P-CSCF and the HSS may be based on the Diameter protocol using UAA/UAR, MAA/MAR and/or SAA/SAR messages known from 3GPP TS29.228 and TS29.229. These vectors may be stored with the P-CSCF. The RF may select an authentication vector and send a challenge comprising RAND (step 412) and AUTN back to the UE for authentication of the user.

Upon reception of the challenge, the UE calculates a response RES which is sent in a further registration message via the SBC to the P-CSCF (step 414). At the P-CSCF the RF may compare XRES with RES and when they match it is decided that the authentication is successful (step 416). The RF thereafter informs the HSS that the UE is registered with the IMS core for a predetermined registration period (step 418) and provides the location server with the IP address of the P-CSCF assigned to the UE (step 420). The registration process is ended by sending SIP 200 OK to the UE (step 422).

FIG. 5 depicts a signaling flow associated with a re-registration procedure 500 according to one embodiment of the invention. In this procedure, upon expiry of the registration period the UE may send a registration message for re-registering with the IMS core to the SBC (step 504). Then, on the basis of the P-CSCF list provided by the location server to the SBC (step 502), SBC may select the P-CSCF initially assigned to the UE (step 506) and send the registration message to the P-CSCF (step 508). The P-CSCF may contact the HSS, in order to check the registration status of the UE (step 510). On the basis of this information it may determine that the UE is already registered and authenticated with the IMS core so that no authentication challenge is required. The P-CSCF then updates the registration timer (step 512) by a predetermined value to that the UE is re-registered for a predetermined time.

In contrast with a conventional IMS registration scheme, the IMS registration schemes as described with reference to FIG. 3 through 5 result in registered UEs, which are not rigidly assigned to a S-CSCF for the whole registration period, thereby allowing conditional assignment of S-CSCF to a UE for a shorter period than the registration period, for example for the period (duration) associated with a session. During a registration period a UE may initiate multiple sessions wherein at each session set-up the IMS system may assign a best-fit S-CSCF to the UE. Hence, such scheme allows real-time load distribution of sessions over the available S-SCSF resources in an IMS network. These sessions may be set-up simultaneously or sequentially or in a combination of the both. They may further relate to the same type or to different types of services requested by a UE or other network.

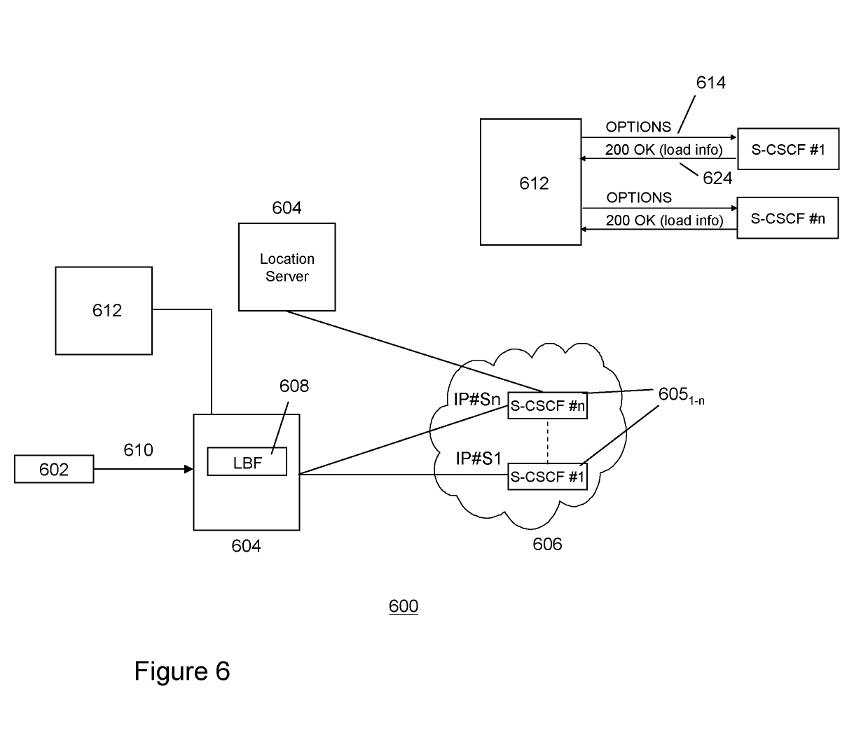

FIG. 6 depicts a schematic of a system 600 for routing a service request according to one embodiment of the invention. In particular, this system comprises a UE or IP-PBX 602 configured for sending service requests, e.g. SIP based service requests not being registeration requests, 610 to a network node 604 comprising or associated with a load balancing function (LBF) 608 which is configured to select a suitable serving network node amongst a pool of available serving network nodes, e.g. a pool of N S-CSCFs 606 (i.e. S-CSCF#1—S-CSCF#N 605₁-605ₙ with associated network addresses IP#S1-IP#Sn).

In one embodiment, the LBF may be comprised in the registering network node, e.g. the P-CSCF or SBC associated with the UE. In other embodiments, the LBF may be located on one a separate network node, e.g. a server, in or associated with the IMS core, which may be accessed by P-CSCF.

The LBF may be configured to request or receive load information from an external network server, which is configured to monitor the load (e.g. the processor load (CPU) and/or response time) experienced by network nodes, in particular the available set of S-CSCFs, in the IMS core due to routing and handling signaling traffic. Alternatively and/or in addition, the LBF may interact with a Load Detection Function (LDF) 612 as described in 3GPP TR 23.812. The LDF may be executed on a separate server which is located somewhere in the IMS network for obtaining the relevant load information for the LBF to enable selection of the most suitable S-CSCF.

The inset of FIG. 6 depicts one embodiment of a LDF collecting load information from S-CSCFs in the IMS core. In this embodiment, the LDF may send a SIP OPTIONS message 614 to a first S-CSCF1 requesting the S-CSCF1 to return processor (CPU) load information in the 200 OK SIP response message 626. Alternatively and/or in addition, the LDF may measure the response time of the S-CSCF. For example it may measure the response time of a SIP message, e.g. a SIP OPTIONS message or another suitable message, and use the time between the transmission of the SIP message an the reception of the response to the SIP message as a parameter for determining the load of a network node. It is submitted that any suitable scheme for collecting load information may be used for the purpose of the invention.

The LBF may request or receive load information associated with available S-CSCFs in the IMS on a regular basis. This information may be stored in a LBF table (a memory cache) and updated such that each time when a load information is required in order to determine a suitable S-CSCF or other network node in the IMS core on the basis of current load information. The LBF may process the load information and select a suitable S-CSCF on the basis of the load information in various ways.

For example, it may select the least loaded S-CSCF, the S-CSCF, which within a predetermined time window is the least loaded or it may randomly select an S-CSCF from a set of S-CSCFs, which have a load below a certain threshold value. In more general, the LBF may select a suitable S-CSCF on the basis of a set of selection rules and the load information.

In one embodiment, the P-CSCF or SBC may store information regarding the UE and its S-CSCF (e.g. UE-ID, S-CSCF ID and the network address of the S-CSCF) in a memory, e.g. serving node table, which may be used by the P-CSCF or SBC in order to route further services requests associated with the same UE directly to the S-CSCF.

This way, when a service request is received by the P-CSCF or the SBC, it may first check whether the serving node table has registered an S-CSCF, which was last used by the UE. If this is the case, the P-CSCF or SBC may assign that S-CSCF to the UE. If not, the LBF may be triggered to select an S-CSCF on the basis current load information in the LBF table. The service request may subsequently be forwarded to the thus selected S-CSCF. In response the selected S-CSCF may send an update request to the location server in order to store the location (IP address) of the S-CSCF assigned to the UE. In other embodiments, the location server may be updated by the P-CSCF or SBC.

Hence, the LBF allows the IMS core to select a best-fit S-CSCF at each service request of a UE on the basis of current load information and/or on information associated with previously assigned S-CSCFs. Such system is thus capable of rapidly responding to load change in individual network nodes of the IMS core thereby effectively preventing overload situations.

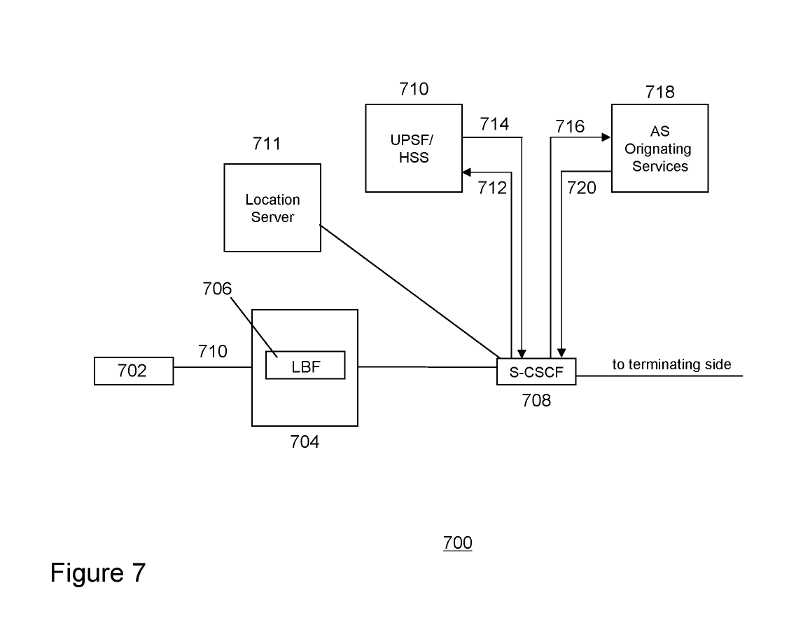

FIG. 7 depicts a schematic of system 700 for routing an originating service request according to another embodiment of the invention. In particular, FIG. 7 depicts a system wherein a UE or an IP-PBX (NGCN) 702 is registered to the IMS core using a registration procedure as described with reference to FIG. 3-5. Upon receipt of a service request 710 from the UE, the P-CSCF or SBC 704 comprising or associated with a load balancing function (LBF) 706 may identify on the basis of the serving node table that a particular S-CSCF was previously used by the UE. The P-CSCF may then assign the identified S-CSCF to the UE. In one embodiment, the LBF may first check whether the load associated with the identified S-CSCF is below a predetermined level before it is assigned to UE.

Thereafter, the service request is relayed to the assigned S-CSCF 708. Upon reception of the service request, the S-CSCF may first check whether it has the service profile of the UE or the IP-PBX available in its cache. If this is not the case, the S-CSCF may send a service profile request 712 to the UPSF/HSS 710, which in response 714 returns the profile. Further, the S-CSCF (or the P-CSCF; not shown) may update the location database in view of the renewal of the assignment of the S-CSCF.

Then, on the basis of the iFCs in the user profile, the S-CSCF routes the service request 716 to an application server 718 or a several chained application servers (O-AS) comprising the originating service as indicated in the service request. This service may be executed and the service request 720 may be further relayed to the terminating side of the IMS core.

Hence, in contrast with the conventional way of routing an originating request in an IMS core, the S-CSCF, which was not involved in the initial registration of the UE, first checks whether it should request the user profile of the UE or IP-PBX. In some cases, the service profile may have been already stored in the cache in an earlier session. In that case, no service profile request is issued to the HSS.

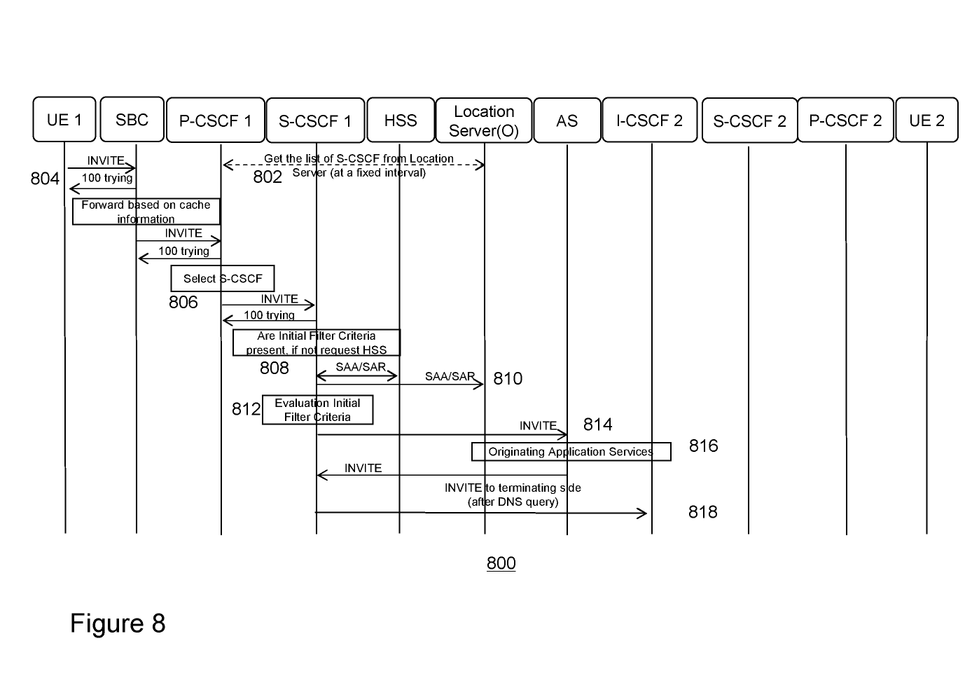

FIG. 8 depicts a signaling flow 800 associated with a process for setting up the originating side of a session. In this scheme, the P-CSCF may regularly receive a list comprising location information, i.e. the IP addresses of the available S-CSCFs, from a location server (step 802) and preferably based on information from a load detection function (LDF) as proposed in 3GPP TR 23.812. Then, if a UE sends a service request to the IMS core, the message is relayed via the SBC to the P-CSCF it is registered to (step 804). Upon receipt of the service request, the P-CSCF may initiate selection of a best-fit S-CSCF. Selection may include checking which S-CSCF was previously assigned to the UE. If such S-CSCF is identified, the P-CSCF may directly route the service request to the identified S-CSCF.

Alternatively, the LBF may check whether on the basis of load information whether the load associated with the identified S-CSCF is below a certain threshold. If the load is above the threshold or if an S-CSCF is not found, the LBF may be triggered to select a suitable S-CSCF (step 806) on the basis the load information as described in more detail with reference to FIG. 6. After selection of the S-CSCF, the service request is forwarded to the S-CSCF, which requests the user profile associated with the UE from the HSS if it cannot find such profile in its cache (step 808). Further, and the location database is updated with the S-CSCF assigned to the originating UE (step 810). After evaluation of the iFC in the user profile (step 812), the service request is forwarded to an application server comprising an originating service (step 814). After execution of the originating service (step 816) the service request is further routed by the S-CSCF to the terminating side (step 818).

FIG. 9 depicts a schematic of a system 900 for routing a terminating service request according to one embodiment of the invention. In this case, when an S-CSCF(O) 902 associated with the originating side receives a terminating service request, it first may query a first location request 904 to a location server 908 in order to find out whether a S-CSCF(T) is already assigned to the UE at the terminating side and if so to receive information regarding the last used (assigned) S-CSCF to the terminating UE.

If this is the case, the location server may send the location information of the S-CSCF(T) in a response message 906 to the S-CSCF(O), which subsequently forwards the terminating service request to this terminating serving node 910. Upon reception, the S-CSCF(T) forwards the terminating service request 912 to one or more application servers (T-AS) 914 comprising the terminating service. Further, the S-CSCF(T) may query the location server with a location update 915 regarding the current S-CSCF(T) assigned to the terminating UE.

After executing the terminating service, the service request 916 is sent back to the S-CSCF(T) for further completion of the session set-up.

To that end, the S-CSCF(T) sends the service request to an I-CSCF 918, which in response may send a query 920 to the location server (which may be co-located with the UPSF/HSS; not shown) in order to retrieve location information regarding the P-CSCF assigned to the terminating UE. After having received the location information of the assigned P-CSCF, the terminating service request is sent via the P-CSCF 922 to the destination, e.g. a terminating UE or IP-PBX 924.

FIG. 9b depicts a schematic of a system 900b for routing a terminating service request according to one embodiment of the invention. In this case, when an S-CSCF(O) 902b associated with the originating side needs to forward a service request to the terminating side, it first may send a first location request 904b to a general location server 908b (i.e. DNS) for the address of the I-CSCF (or IBCF) of the terminating side. This I-CSCF 910b, on receipt of the terminating service request then sends a location request 905b to a location server 909b on the terminating side in order to find out whether an S-CSCF(T) is already assigned to the UE at the terminating side and if so to receive information regarding the last used (assigned) S-CSCF to the terminating UE. If this is the case, the location server 909b may send the location information of the previously assigned S-CSCF(T) in a response message 907b to the I-CSCF(T), which subsequently forwards the terminating service request to this terminating serving network node (S-CSCF(T)) 910b. Upon receipt, the S-CSCF(T) forwards the terminating service request 912b to one or more application servers (T-AS) 914b arranged for providing one or more application services for the destination of the session setup. Further, the S-CSCF(T) may inform the location server 909b with a location update 915b regarding the current S-CSCF(T) assigned to the terminating UE.

After executing the terminating service, the service request 916b is sent back to the S-CSCF(T) for further completion of the session set-up.

To that end, if the user profile of the terminating UE is not present in the cache of the selected S-CSCF(T),the S-CSCF queries 920b the location server 909b (which may be co-located with the UPSF/HSS; not shown) in order to retrieve location information, e.g. a network address, as stored at registration on the basis of the path header by the selected S-CSCF in the HSS/UPSF (see FIG. 2b), for locating the P-CSCF assigned to the terminating UE. After having received the location information of the assigned P-CSCF, the terminating service request is sent via the P-CSCF 922b to the destination, e.g. a terminating UE or IP-PBX (NGCN) 924b.

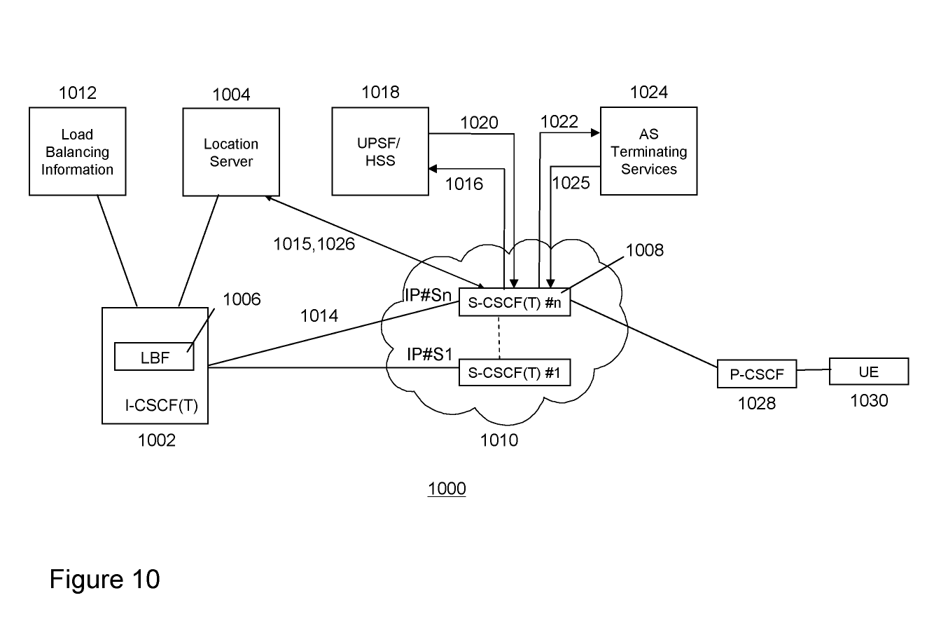

FIG. 10 depicts a signaling flow 1000 of a system for routing a terminating service request according to yet another embodiment of the invention. In this example, the terminating I-CSCF (or IBCF) 1002 receives, upon request, a message from the location server 1004 that no S-CSCF(T) is assigned to the terminating UE. Hence, in that case the I-CSCF may trigger a LBF 1006 to selected a suitable terminating S-CSCF(T) 1008 from a pool of available S-CSCFs 1010 on the basis of current load information 1012. After the LBF having selected a suitable S-CSCF(T), the service request 1014 may be routed to that S-CSCF(T), which may send a notification 1015 to the location server for updating its stored information regarding the actual S-CSCF(T) assigned to the terminating UE.

Then, if the user profile of the terminating UE is not present in the cache of the selected S-CSCF(T), a user profile request 1016 may be sent by the S-CSCF(T) to the UPSF/HSS 1018, which in response 1020 transmits the requested user profile to the S-CSCF(T). The service request 1022 is subsequently sent to one or more terminating application servers 1024 on the basis of the iFCs in the user profile. The service request 1025 may then be routed back to the S-CSCF(T). Further, the S-CSCF(T) may send a query 1026 to the location server for requesting location information, e.g. a network address, for locating the P-CSCF assigned to the terminating UE. On the basis of the requested location information, the service request is subsequently sent via the P-CSCF 1028 to the terminating UE 1030.

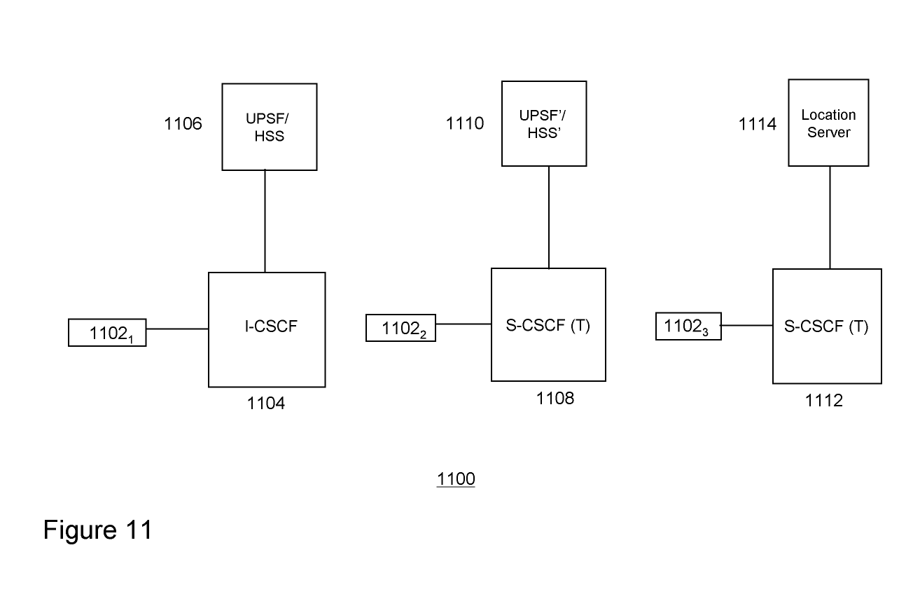

FIG. 11A-11C depict schemes for P-CSCF localisation according to various embodiments of the invention. FIG. 11A depicts an embodiment wherein, in response to a service request originating from an UE 1102₁, an I-CSCF 1104 is used for requesting the location of a P-CSCF associated with a terminating UE from a location database. In such scheme the location database is co-located with the UPSF/HSS 1106 so that the conventional Diameter-based Cx interface between the I-CSCF and the UPSF/HSS may be used to request the location information.

FIG. 11B depicts an embodiment wherein, in response to a service request from an UE 1102₂, the S-CSCF(T) 1108 may request the P-CSCF location via the Diameter-based Cx interface between the S-CSCF and the UPSF'/HSS' 1110 using a profile download based on SAA/SAR messages. Hence, in that case, the downloaded user profile comprises the P-CSCF location associated with the terminating UE. Although such location retrieval would be efficient in terms of signaling, this solution requires that the user profile in the UPSF/HSS also comprises the location of the P-CSCF.

Finally, FIG. 11C depicts an embodiment wherein in response to a service request from an UE 1102₃ the S-CSCF(T) 1112 requests the location of the P-CSCF from a SIP location server 1114 using the Diameter messages Location Information Request (LIR) and Location Information Answer (LIA).

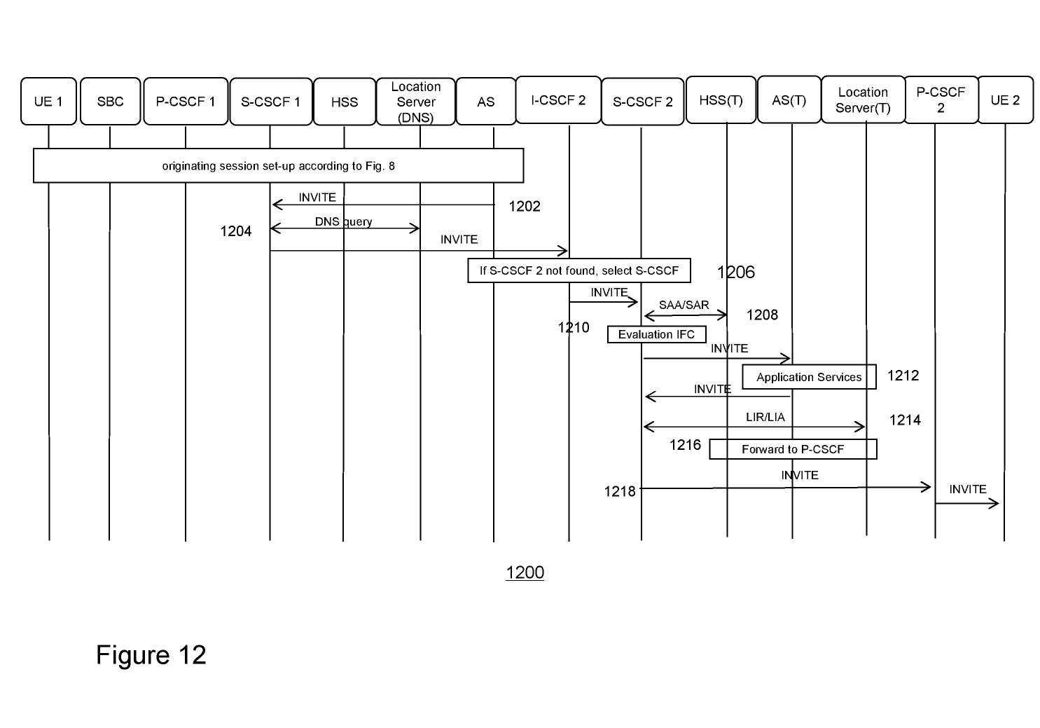

FIG. 12 depicts a signaling flow 1200 associated with a process for setting up the terminating side of a session. Hence, this signaling flow is the logical sequence of the originating session set-up as described with reference to FIG. 8. In that case, the signaling starts with an AS returning the service request back to the originating S-CSCF(O) (step 1202), which subsequently queries a location server (DNS; step 1204) in order to find the location of the terminating side (domain of destination) and then forwards the request to the entrance of the terminating network side, I-CSCF or IBCF (not shown). The terminating I-CSCF determines whether an S-CSCF(T) is assigned to the terminating UE. If this is not the case, the I-CSCF(T) may trigger a LBF in order to retrieve a suitable S-CSCF(T) as described in more detail with reference to FIG. 10. After selecting a suitable S-CSCF(T) (step 1206), the service request is routed to this terminating S-CSCF(T), which request a user profile download if the user profile associated with the terminating UE is not present in its cache (step 1208). After having received the user profile and evaluation of the iFCs (step 1210), the service request is relayed to the appropriate AS for executing one or more terminating services (step 1212). The service request is then returned to the S-CSCF(T) which requests from a location server which is co-located with the HSS (step 1214) the location of the P-CSCF assigned to the terminating UE. After the P-CSCF is found (step 1216), the service request is subsequently relayed via the P-CSC to the terminating UE (step 1218).

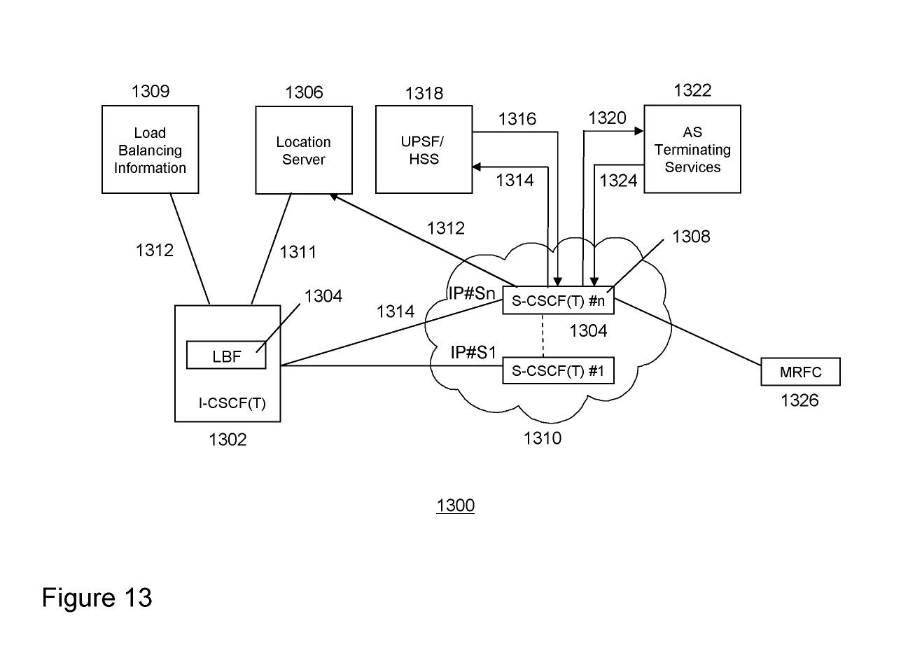

FIG. 13 depicts a schematic of a system 1300 for routing a terminating service request according to a further embodiment of the invention. In this case, the system is configured to execute a signaling scheme, which similar to the one described with reference to FIG. 10. Hence, the I-CSCF(T) 1302 triggers the LBF 1304 after having received a response from the location server 1306 that no S-CSCF(T) is assigned to the terminating UE. An S-CSCF(T) 1308 selected by the LBF on the basis of load information 1309 from a pool of available S-CSCFs 1310 queries 1312 the location server that its has been assigned to the terminating UE and initiates a user profile download 1314,1316 from the UPSF/HSS 1318 in a similar way as depicted in FIG. 10. The information in the user profile of the terminating UE however indicates in this case that the terminating UE is not registered with the IMS core. The S-CSCF(T) then relays the service request 1320 on the basis of the iFCs to a terminating AS 1322 for handling the session associated with the non-registered terminating UE, e.g. a voice-mail service. The service request 1324 is then further relayed to a Multimedia Resource Function Controller (MRFC) 1326 for further handling of the session. In this example, wherein the terminating UE is not registered with the IMS core, the MRFC will provide an appropriate fault handling like a voice announcement to the originating caller that the terminating user cannot be reached.

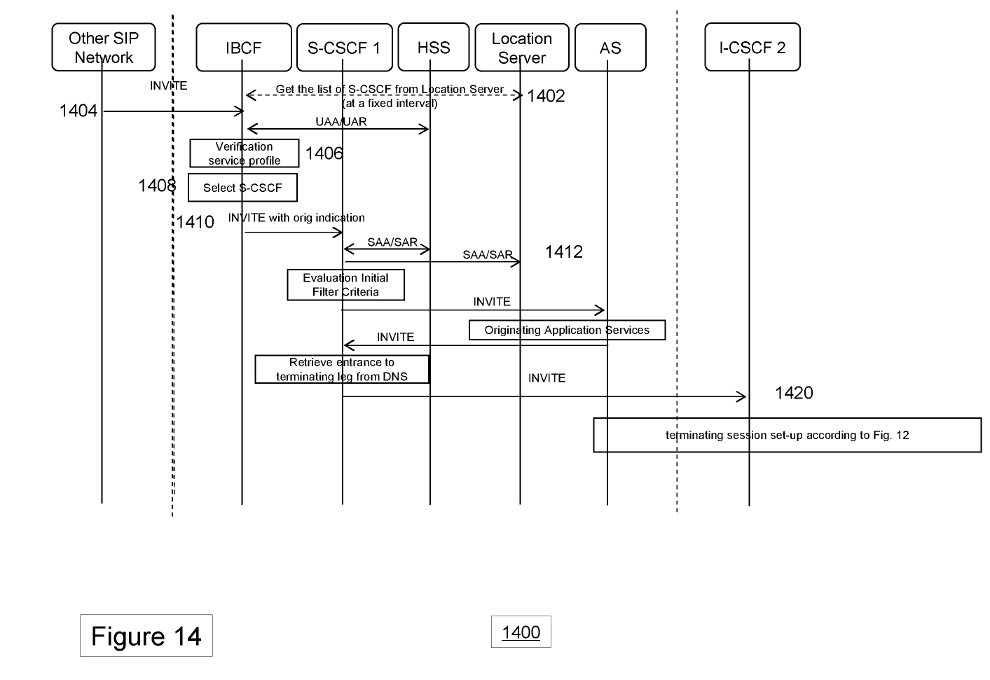

FIG. 14 depicts a signaling flow 1400 associated with a process for setting up a session according to yet another embodiment of the invention. In particular, the embodiment of FIG. 14 depicts a signaling flow wherein a session is set up on the basis of a service request originating from another network.

In this embodiment, the process starts at an I-CSCF (or IBCF) receiving a service request originating from another, preferably SIP supporting (e.g. capable of signaling through the use of SIP messages), network (step 1404). If the other network performs the originating functions, the IBCF (or I-CSCF) is the entry for the terminating side as described in detail with references to FIGS. 6 and 10.

However in this embodiment a specific case, e.g. on peering based business trunking, is described, wherein the (IMS) network is organized to perform originating services to the originating network (e.g. other network such NGCN/IP-PBX, public network). Then the IBCF (or I-CSCF) may be configured to behave in a similar manner as the P-CSCF in the basic cases described with reference to FIG. 6. So the I-CSCF or IBCF may be configured to regularly receive a list comprising location information, i.e. the IP addresses of the available S-CSCFs, from a location server (step 1402). Upon reception of the service request, the I-CSCF may first verify the credentials of the originating network and if originating services are to be provided, the service request, e.g. the request for a session setup (SIP INVITE message), will be forwarded by the IBCF/I-CSCF to an S-CSCF with an added appropriate indication (e.g. the orig-parameter as described in 3GPP 23.228 and 24.229), which forces the S-CSCF to perform originating functionality. Comparable with the process illustrated in FIG. 8 the IBCF (or I-CSCF) will select the S-CSCF on the basis of information from a location server.

So after selection of the S-CSCF, the service request is forwarded to the S-CSCF(O) (step 1410) with an indication that forces the S-CSCF to perform originating procedures, Thereafter, the location server is updated with the selected S-CSCF(O) and the session is set-up in a similar way as described with reference to FIG. 8 for the signaling flows for a session set up for the originating and FIG. 12 for the signaling flows for the terminating part.

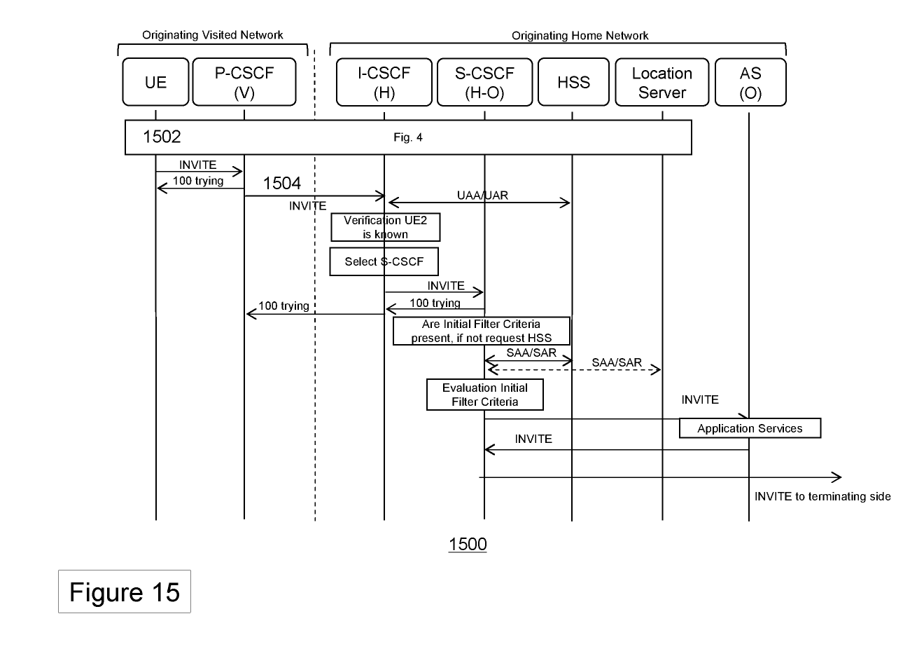

FIG. 15 depicts a signaling flow 1500 associated with a process for setting up a first part of a session in a roaming situation. In this scheme, both the visited and the home network are configured to select serving network nodes, S-CSCFs, in response to a service request, e.g. SIP INVITE message. In that case, an originating UE may register itself to its home network using e.g. the registration procedure as depicted in FIG. 4 (step 1502), wherein the registration will be executed by a registration function RF associated with a P-CSCF or an SBC (comprising P-CSCF functionality) in the originating visited network and wherein the location of the assigned P-CSCF(V) or SBC(V) is stored in a location database of the originating home network.

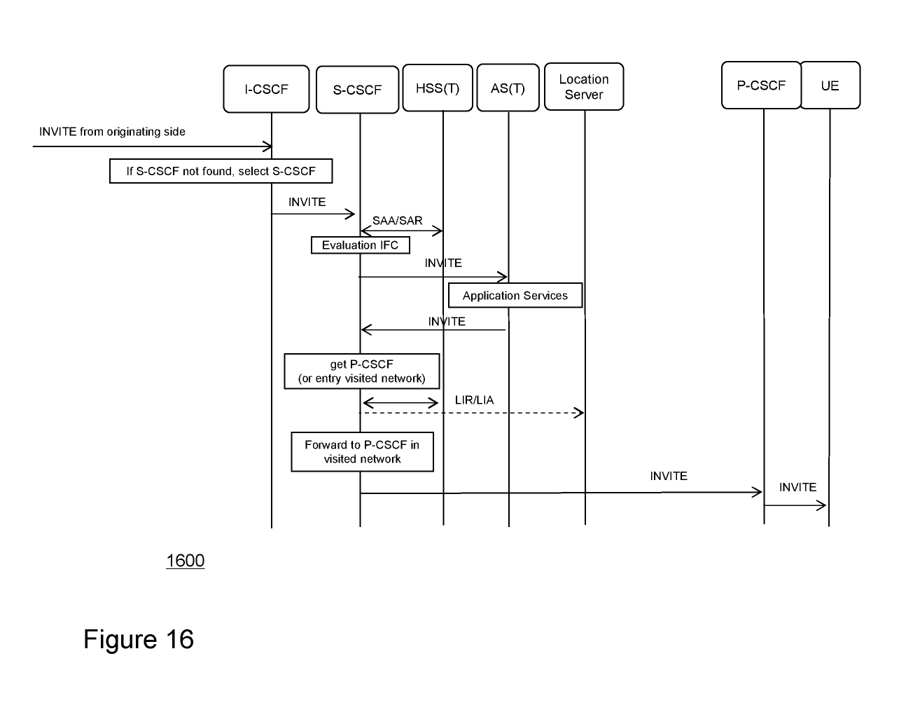

When a roaming UE wants to set-up a session with a terminating UE, a service request is sent via the P-CSCF(V) to the I-CSCF(H) of the originating home network (step 1504). Thereafter, the session set-up process in the originating part and terminating part of the home network (which is depicted in detail in FIG. 16) is handled in a similar way as described with reference to FIG. 14.

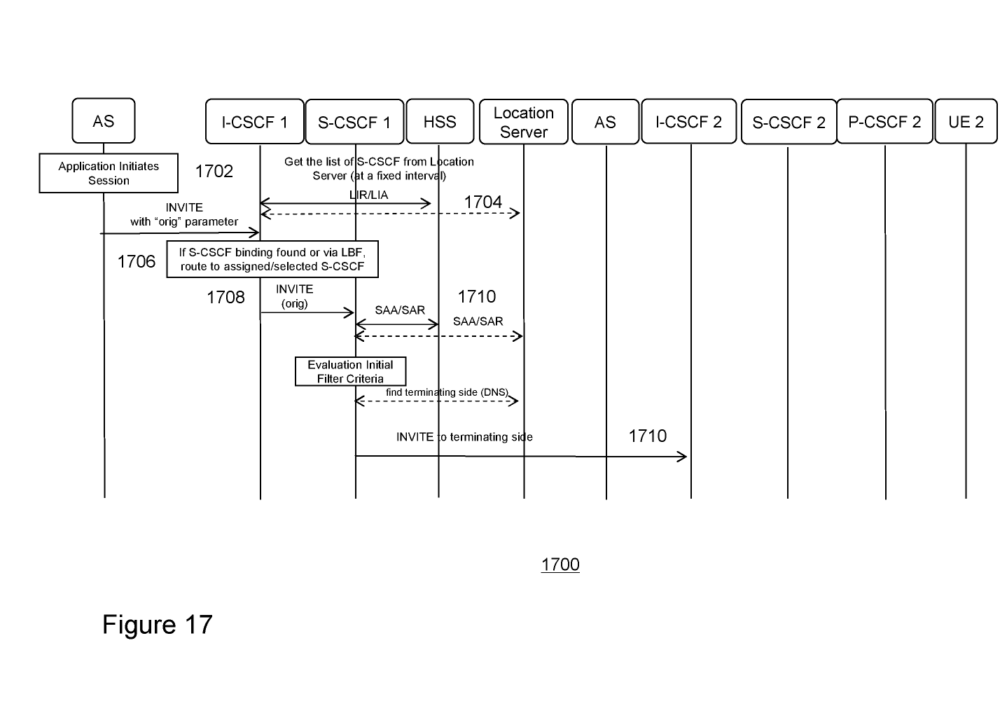

FIG. 17 depicts a signaling flow 1700 associated with a process for setting up a session with a terminating UE wherein an application server (network node) acts as source of the service request. In that case, the process is started with the AS sending the service request to the I-CSCF 1702 with an indication (e.g. the orig-parameter as described in 3GPP 23.228 and 24.229) that this service request is to be treated as an originating request (such as a request for a session set-up, e.g. a SIP INVITE).

The I-CSCF selects on the bases of available (provided) load information 1704 a best-fit originating S-CSCF(O) (step 1706) wherein the selection may include checking which S-CSCF was previously assigned to the AS. If such S-CSCF is identified, the I-CSCF may send the service request directly to the identified S-CSCF.

Alternatively, the I-CSCF may request a LBF for check whether the load associated with the identified S-CSCF is below a certain threshold. If this is the case, and the I-CSCF has received feedback from the LBF, the service request may be sent by the I-CSCF to the identified S-CSCF.

If the load associated with the identified S-CSCF is too high or if a previously assigned S-CSCF is not found, the LBF may be triggered and a suitable S-CSCF may be selected on the basis of the provided load information as described in more detail with reference to FIG. 6 (step 1706). After selection of the S-CSCF, the service request is forwarded to the assigned S-CSCF (step 1708), which at its turn requests the profile associated with the AS from the HSS, if it cannot find such profile in its cache (step 1710). Further, it may update the location database with the S-CSCF assigned to the AS (step 1710). Thereafter, the service request is forwarded to the terminating side and treated there in a similar way as described with reference to FIG. 12 for the signaling flows for a session set up for the terminating part

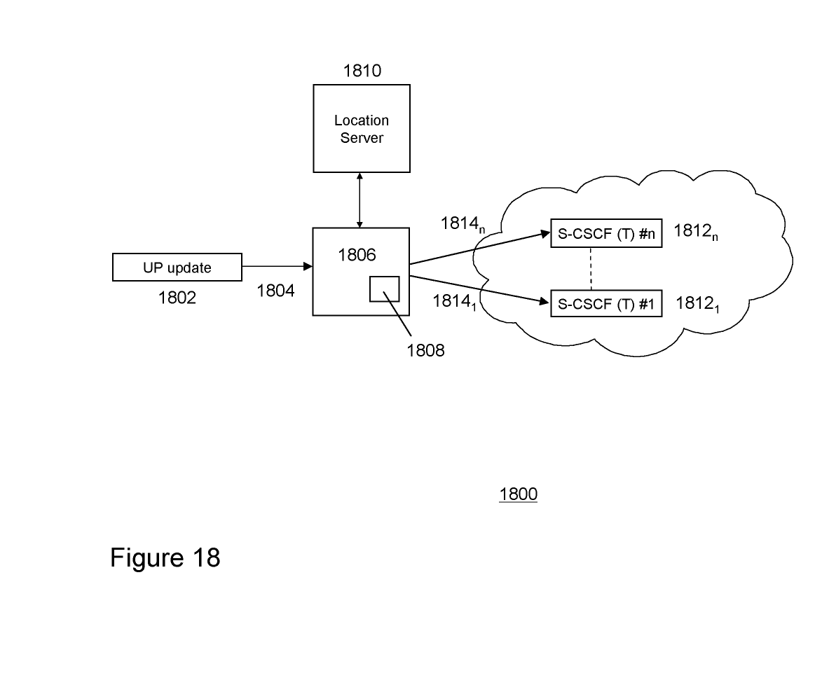

FIG. 18 depicts a scheme 1800 for updating a user profile according to one embodiment of the invention. In particular, FIG. 18 depicts a network node 1802 configured for sending a request 1804 for a user profile update to the UPSF/HSS 1806. In response to this request a profile update function (PUF) 1808 in the UPSF/HSS is triggered. The PUF processes the update by storing the modified profile into the profile database. Further, it requests the location server 1810 for the location information of all available S-CSCFs 1812₁₋ₙ. Thereafter, it sends on the basis of the location information refresh messages 1814₁₋ₙ comprising a user profile identifier to all S-CSCFs. Upon reception of the refresh message, each S-CSCF checks on the basis of the identifier whether the (old) user profile is stored in its memory (cache) and if this is the case, that user profile entry is deleted.

The profile update scheme as depicted in FIG. 18 ensures an S-SCSF does not process messages on the basis of user profiles which are no longer valid. This way an S-CSCF will always uses the most recent user profile available in the UPSF/HSS.

It is to be understood that any feature described in relation to any one embodiment may be used alone, or in combination with other features described, and may also be used in combination with one or more features of any other of the embodiments, or any combination of any other of the embodiments. One embodiment of the invention may be implemented as a program product for use with a computer system. The program(s) of the program product define(s) functions of the embodiments (including the methods described herein) and may be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Moreover, the invention is not limited to the embodiments described above, which may be varied within the scope of the accompanying claims.

1. Method for dynamic assignment of a serving network node in a communications network comprising a predetermined number of serving network nodes, said method comprising:
receiving a service request associated with a user equipment, another network, or a network node;
providing load information associated with said serving network nodes;
in response to said service request, assigning one of said predetermined number of serving network nodes to said user equipment, said other network or said network node on the basis of said load information.

2. Method according to claim 1, wherein said load information is provided in response to said service request.

3. Method according to claim 1, wherein said load information is provided at predetermined time intervals.

4. Method according to claim 1 wherein said communications network further comprises a location database containing location information associated with said predetermined number of serving network nodes.

5. Method according to claim 1 wherein said load information comprises response time information and/or CPU resource information associated with at least part of said serving network nodes associated with at least part of said serving network nodes.

6. Method according to claim 1 comprising:
receiving a list identifying at least part of said predetermined number of serving network nodes, said list further comprising location information associated with said serving network nodes;
receiving load information associated with at least part of said predetermined number of serving network nodes;
selecting a serving network node from said list on the basis of selection rules and said load information;
assigning said selected serving network node to said user equipment, said other network or said application server.

7. Method according to claim 1 further comprising:
registering an user equipment on the basis of an access network node associated with said communications network.

8. Method according to claim 7 comprising:
assigning an access network node at the border of said communications network to said user equipment;
executing a registration function associated with said access network node;
storing said registration in a subscriber database comprising user profiles associated with subscribers to services of said communications network;
storing location information in a location database.

9. Method according to claim 1 further comprising:
sending said service request to said assigned serving network node;
the assigned serving network node requesting a user profile associated with said user equipment if a memory of said assigned serving network node does not comprise said user profile.

10. Method according to claim 1 further comprising:
routing said service request to an application server comprising a service associated with the service request.

11. Method according to claim 4 wherein said service request is a terminating service request and wherein said location database further comprises location information associated with access network nodes assigned to user equipment registered with the communications network, said method further comprising:
if the terminating user equipment associated with said terminating service request is registered with said communications network, requesting said location database for the location information associated with said access network node assigned to said terminating user equipment.

12. Method according to claim 11 comprising:
routing said terminating service request via said access network node to said terminating user equipment.

13. Method according to claim 1 comprising:
updating a user profile associated with a subscriber to services of said communications network;
in response to said user profile update, deleting one or more user profiles stored in a memory of at least part of said predetermined number of serving network nodes.

14. Method according to claim 13 further comprising:
sending a user profile update message to a subscriber database comprising user profiles associated with subscribers to services of said communications network;
updating said user profile in said subscriber database;
said subscriber database requesting location information associated with at least a part of said predetermined number of serving network nodes;
transmitting a user profile refresh message to said serving network nodes;
if said user profile is stored in a memory, removing the said user profile entry from said memory.

15. Method according to claim 1 wherein said service request is received by an SBC, an P-CSCF, an IBCF, an S-CSCF or an I-CSCF.

16. Method according to claim 1 wherein said location database is co-located with said UPSF/HSS or wherein said location database is located on a separate network node.

17. Network node configured for dynamic assignment of a serving network node in a communications network, said network node comprising:
means for receiving a service request associated with an user equipment, another network or a network node;
means for providing load information associated with at least part of said predetermined number of serving network nodes;
means for assigning one of said predetermined number of serving network nodes to said user equipment or said network node when said receiver receives a service request, said assigning being based on said load information.

18. Network node according to claim 16 further comprising:
means for sending assignment information identifying user equipment or an network node assigned to at least one of said predetermined number of serving network nodes.

19. Network node according to claim 17 further comprising:
means for receiving a user profile refresh message;
means for removing a user profile entry from a memory of said network node if said memory comprises the user profile identified in said user profile refresh message.

20. A subscriber database server comprising user profiles associated with subscribers to a communications network, said communications network comprising a predetermined number of serving network nodes and a least one network node configured for dynamic assignment of a serving network node to a user equipment or an application server, said server comprising:
means for updating a user profile stored in a memory of said server;
means for receiving location information associated with at least a part of said predetermined number of serving network nodes;
means for transmitting a user profile refresh message to said serving network nodes, so that if said user profile is stored in a memory of one or more of said serving network nodes, said serving network node will remove said user profile entry from said memory.

21. A location server for use with a network node, said server comprising a location database comprising location information associated with said predetermined number of serving network nodes; assignment information identifying user equipment, another network or a network node assigned to at least one of said predetermined number of serving network nodes; and location information associated with access network nodes assigned to user equipment registered with the communications network, said location server comprising:
means for receiving and transmitting assignment information identifying user equipment, another network or a network node assigned to at least one of said predetermined number of serving network nodes;
means for receiving and transmitting location information associated with said predetermined number of serving network nodes and/or said with access network nodes assigned to user equipment registered with the communications network.

22. Communications system configured for dynamic assignment of a serving network node to at least one user equipment, another network or a network node, said communications system comprising:
at least one network node comprising:
means for receiving a service request associated with an user equipment, another network or a network node;
means for providing load information associated with at least part of said predetermined number of serving network nodes; and
means for assigning one of said predetermined number of serving network nodes to said user equipment or said network node when said receiver receives a service request, said assigning being based on said load information;
a subscriber database server comprising:
means for updating a user profile stored in a memory of said server;
means for receiving location information associated with at least a part of said predetermined number of serving network nodes; and
means for transmitting a user profile refresh message to said serving network nodes, so that if said user profile is stored in a memory of one or more of said serving network nodes, said serving network node will remove said user profile entry from said memory; and
a location server comprising:
means for receiving and transmitting assignment information identifying user equipment, another network or a network node assigned to at least one of said predetermined number of serving network nodes; and
means for receiving and transmitting location information associated with said predetermined number of serving network nodes and/or said with access network nodes assigned to user equipment registered with the communications network.

23. A computer readable storage medium containing a set of instructions that, when executed by a processor, performs a method for dynamic assignment of a serving network node in a communications network comprising a predetermined number of serving network nodes, said method comprising:
receiving a service request associated with a user equipment, another network, or a network node;
providing load information associated with said serving network nodes; and
in response to said service request, assigning one of said predetermined number of serving network nodes to said user equipment, said other network or said network node on the basis of said load information.

24. Method according to claim 1, wherein said communications network comprises an IMS-based communications network.

25. Method according to claim 1, wherein said network node comprises an application server.

26. Method according to claim 4, wherein said location database further comprises assignment information identifying user equipment, another network or a network node assigned to at least one of said predetermined number of serving network nodes.

27. Method according to claim 7, further comprising storing location information associated with said assigned serving network node in said location database.

28. Method according to claim 8, wherein said access network node comprises a P-CSCF or a session border controller.

29. Method according to claim 8, wherein said subscriber database comprises a UPSF/HSS.

30. Method according to claim 8, wherein storing location information includes storing the network address associated with said access network node.

31. Method according to claim 14, wherein said subscriber database comprises a UPSF/HSS.

32. Network node according to claim 17, wherein said network node comprises an SBC, an P-CSCF, an IBCF, an S-CSCF or an I-CSCF.

33. Network node according to claim 17, wherein said communications network comprises an IMS-based communications network.

34. Network node according to claim 17, wherein said network node comprises an application server.

35. Network node according to claim 17, wherein said load information comprises response time information and/or CPU resource information.

36. Subscriber database server according to claim 20, wherein said network node comprises an SBC, an P-CSCF, an IBCF, an S-CSCF or an I-CSCF.

37. Location server according to claim 21, wherein said location information comprises network addresses.
